(19) United States
(12) Patent Application Publication
(10) Pub. No.: US 2002/0012845 A1
(43) Pub. Date: Jan. 31, 2002

(54) Negative active material for rechargeable lithium battery and method of preparing the same

(76) Inventors: Wan-Uk Choi, Suwon-city (KR); Kyou-Yoon Sheem, Cheonan-city (KR); Sang-Jin Kim, Cheonan-city (KR); Jae-Yul Ryu, Cheonan-city (KR); Sang-Young Yoon, Cheonan-city (KR)

Correspondence Address: CHRISTIE, PARKER & HALE, LLP, 350 WEST COLORADO BOULEVARD, SUITE 500, PASADENA, CA, 91105, US

(21) Appl. No.: 09/880,634

(22) Filed: Jun. 11, 2001

(30) Foreign Application Priority Data
Jun. 16, 2000 (KR) 2000-33298

(51) Int. Cl. H01M 4/58; C01B 31/30

(52) U.S. Cl. 429/231.8; 423/439; 429/218.1

(57) ABSTRACT

The present invention relates to a negative active material for a rechargeable lithium battery and a method of preparing the same, said negative active material comprising crystalline carbon having a dispersed element serving as graphitization catalyst therein. Said negative active material for a rechargeable lithium battery is prepared by the steps of adding an element serving as a graphitization catalyst to a carbon precursor; coking the mixture by heat-treating at 300 to 600° C. carbonizing the cokes; and graphitizing the carbide at 2800 to 3000° C.

### CROSS REFERENCE TO RELATED APPLICATION

This application is based on application No. 2000-33298 filed in the Korean Industrial Property Office on Jun. 16, 2000, the disclosure of which is incorporated herein by reference.

### FIELD OF THE INVENTION

The present invention relates to a negative active material for a rechargeable lithium battery and a method of preparing the same. More particularly, the present invention relates to a negative active material for a rechargeable lithium battery with high capacity and excellent charge-discharge efficiency and a method of preparing the same.

### BACKGROUND OF THE INVENTION

For positive and negative active materials, rechargeable lithium batteries use a material from or into which lithium ions are reversibly intercalated or deintercalated. For an electrolyte, an organic solvent or polymer is used. Rechargeable lithium batteries produce electric energy by electrochemical oxidation and reduction, which take place during the intercalation and deintercalation of lithium ions.

For the negative active material in rechargeable lithium batteries, metallic lithium was used in the early period of development. However, metallic lithium causes an abrupt loss in capacity during charging and discharging, and is deposited in the form of dendrites, which reduce the life span of the battery by disruption of the separator. In order to solve the above problems, there have been attempts to use lithium alloy instead of metallic lithium. However, problems encountered with the use of metallic lithium remain and are not substantially improved.

Recently, carbon-based materials that can intercalate or deintercalate lithium ions are largely used as a negative active material. The carbon-based materials include a crystalline carbon and an amorphous carbon. The crystalline carbon includes artificial graphite and natural graphite. Typical examples of artificial graphite include mesophase carbon microbeads or carbon fibers which are prepared by heat-treating pitch, extracting mesophase sphere or spinning it in a fiber form, stabilizing, and carbonizing or graphitizing it. Such artificial graphite has shortcomings such as low discharge capacity, but has a high charge-discharge efficiency. On the other hand, natural graphite has a relatively high charge-discharge capacity, but has shortcomings such as low charge-discharge efficiency due to high reactivity with the electrolyte, and poor high-rate efficiency and cycle life characteristics due to the plate-shape of powder particles.

Therefore, although there have been attempts to use the advantages of both artificial graphite and natural graphite, it has not yet reached a satisfactory level.

### SUMMARY OF THE INVENTION

The present invention is presented to solve these problems, and accordingly, it is an object of the present invention to provide a negative active material for a rechargeable lithium battery with high capacity and excellent charge-discharge efficiency.

It is another object of the present invention to provide a negative active material for a rechargeable lithium battery in which a wide variety of organic electrolytes can be used.

It is another object of the present invention to provide a method of preparing a negative active material for a rechargeable lithium battery.

In order to achieve the objects, the present invention provides a negative active material for a rechargeable lithium battery comprising crystalline carbon having a dispersed element serving as a graphitization catalyst therein.

The present invention also provides a method of preparing a negative active material for a rechargeable lithium battery comprising:

mixing an element serving as a graphitization catalyst with a carbon precursor;

coking the mixture by heat-treating at 300 to 600° C.;

carbonizing the cokes; and

graphitizing the carbide at 2800 to 3000° C.

### DETAILED DESCRIPTION AND THE PREFERRED EMBODIMENTS

Hereinafter, the present invention will be explained in detail. The negative active material for a rechargeable lithium battery according to the present invention comprises crystalline carbon having a dispersed element which serves as a graphitization catalyst therein. The above element serving as a graphitization catalyst includes at least one of a transition metal, an alkali metal, an alkali earth metal, a semi-metal of Group 3A, Group 3B, Group 4A or Group 4B of the Periodic Table, an element of Group 5A, or an element of Group 5B. Preferably, the transition metal is selected from the group consisting of Mn, Ni, Fe, Cr, Co, Cu, Mo and W; the alkali metal is selected from the group consisting of Na and K; the alkali earth metal is selected from the group consisting of Ca and Mg; the semi-metal of Group 3A is selected from the group consisting of Sc, Y, lanthanoids and actinoids; the semi-metal of Group 3B is selected from the group consisting of B, Al, and Ga; the semi-metal of Group 4A is selected from the group consisting of Ti and Zr; the semi-metal of Group 4B is selected from the group consisting of Si, Ge, and Sn; the element of Group 5A is selected from the group consisting of V, Nb, and Ta; and the element of Group 5B is selected from the group consisting of P, Sb and Bi.

The element serving as a graphitization catalyst is included in an amount of 0.01 to 22 wt % in the negative active material. If the amount of the catalyst element is less than 0.01 wt %, initial charge-discharge efficiency is not improved significantly since the effect of increasing the graphitization degree of the final active material is small and the surface structure is not modified sufficiently. On the other hand, if the amount of the catalyst element is more than 22 wt %, the excess catalyst element may form a hetero compound, which prohibits the movement of lithium ions. Preferably, the negative active material includes 0.01 to 12 wt % boron (B) and 0.01 to 10 wt % of another catalyst element excluding B. The other catalyst element includes a transition metal such as Mn, Ni, Fe, Cr, Co, Cu, Mo or W; an alkali metal such as Na or K; an alkali earth metal such as Ca or Mg; a semi-metal selected from Group 3A such as Sc, Y, lanthanoids or actinoids, Group 3B such as Al or Ga, Group 4A such as Ti or Zr, and Group 4B such as Si, Ge, or Sn; an element of Group 5A such as V, Nb, or Ta, and Group 5B such as P, Sb, or Bi. When the negative active material comprises B, the boron advantageously acts as an acceptor in the graphitization process so that electron transfer during initial lithium intercalation is accelerated.

In the present invention, the elements serving as a graphitization catalyst disperse into carbon as the activity of the elements increases at high temperature. The elements are capable of increasing the crystallinity of carbon through a mechanism such as carbide formation or carbide decomposition, so that they can increase the amount of intercalation/deintercalation of lithium ions resulting from increments in crystallinity. In addition, the above elements may decrease the side-reaction of a negative active material with an electrolyte.

Hereinafter, a method of preparing a negative active material of the present invention will be described in more detail.

An element serving as a graphitization catalyst or a compound thereof is mixed with a carbon precursor.

The above mixing step may be carried out in either a solid-phase or a liquid-phase. In the liquid-phase mixing, a solvent for the catalyst element or compound thereof includes water, an organic solvent or a mixture thereof. The organic solvent includes ethanol, isopropyl alcohol, toluene, benzene, hexane, tetrahydrofuran or the like. The graphitization catalyst element or compound thereof is preferably added at a concentration to enable uniform mixing. If the concentration is excessively low, it is difficult to dry and mix the solvent uniformly. On the other hand, if the concentration is too high, compounds such as the catalyst element agglomerate, so that the reaction with carbon is not possible.

The mixing step in the liquid-phase may be performed either by mechanically mixing the graphitization catalyst elements or compound thereof, with the carbon precursor, or mixing by spray-drying, spray-pyrolysis, or freeze-drying.

In the mixing step, the catalyst element is preferably added in an amount of 0.01 to 22 wt % on the basis of the carbon precursor. The catalyst element compound is preferably added so the catalyst element is present in the compound in an amount of 0.01 to 22 wt % on the basis of the carbon precursor. More preferably, B of the catalyst elements is present in an amount of 0.01 to 12 wt % on the basis of the carbon precursor and one or more of the other catalyst elements excluding B are present in an amount of 0.01 to 10 wt % on the basis of the carbon precursor.

The catalyst element may be one or more of a transition metal; an alkali metal; an alkali earth metal; a semi-metal of Group 3A, Group 3B, Group 4A, and Group 4B; an element of Group 5A and 5B. Preferred are transition metals such as Mn, Ni, Fe, Cr, Co or Cu; alkali metals such as Na or K; alkali earth metals such as Ca or Mg; semi-metals of Group 3A such as Sc, Y, lanthanoids or actinoids; semi-metals of Group 3B such as B, Al or Ga; semi-metals of Group 4A such as Ti or Zr; semi-metals of Group 4B such as Si, Ge or Sn; elements of Group 5A such as V, Nb or Ta; elements of Group 5B such as P, Sb, or Bi. Any compound, for example, oxides, nitrides, carbides, sulfides and hydroxides, can be used as the compound of the graphitization catalyst, if they include a graphitization catalyst element.

The above carbon precursor includes coal-based pitch, petroleum-based pitch, mesophase pitch, or tar, which are prepared by heat-treating coal-based carbon material, petroleum-based carbon material, resin-based carbon and the like.

The obtained mixture is subjected to heat-treatment at 250 to 450° C. for 2 to 10 hours to remove volatile components and generating gas such as CO₂, and then heat-treated at 450 to 650° C. for 1 to 6 hours to prepare cokes.

The cokes are subjected to heat-treatment at 800 to 1200° C. for 2 to 10 hours to prepare carbide.

The carbide is subjected to heat-treatment at 2800 to 3000° C. for 0.1 to 10 hours under inert atmosphere or an air sealing atmosphere. According to the present invention, the use of the graphitization catalyst element facilitates the preparation of a crystalline carbon with increased crystallinity in the heat-treating step. As a result of the heat-treatment of the compound of the graphitization catalyst element, only the graphitization catalyst element remains inside the final resultant negative active material. Furthermore, the amount of the element from the graphitization catalyst element, or the compound thereof, may be reduced as they can be volatilized in the heat-treatment step.

As described above, when carbide is subjected to heat-treatment at 2800 to 3000° C. to obtain a negative active material, the material has an intensity ratio I(110)/I(002) which is defined as a CuKα X-ray intensity I(110) at a (110) plane to the X-ray diffraction peak intensity I(002) at a (002) plane of less than or equal to 0.04. As the intensity ratio of the X-ray diffraction decreases, capacity increases. Generally, natural graphite having high capacity has the intensity ratio of less than or equal to 0.04. Therefore, the negative active material of the present invention provides a battery with high capacity.

The present invention is further explained in more detail with reference to the following examples. These examples, however, should not in any sense be interpreted as limiting the scope of the present invention.

### EXAMPLE

### Example 1

Boric acid was added to coal tar pitch. The amount of boric acid was 7 wt % of the amount of pitch. The above mixture was subjected to heat-treatment at 300° C. for 3 hours while stirring in the reactor under nitrogen to remove volatile components and generating gas such as CO₂, and then subject to heat-treatment at 600° C. to prepare cokes.

After carbonizing the prepared cokes at 1000° C. for 2 hours, the obtained carbide was graphitized at 2800° C. under inactive atmosphere to prepare a negative active material for a rechargeable lithium battery .

The prepared negative active material powder was mixed with the binder of polyvinylidene fluoride and a solvent of N-methylpyrrolidone to prepare a slurry, which was thinly coated on copper foil and dried to prepare an electrode plate. A 2016 type rechargeable lithium battery was prepared using the electrode plate prepared as above, a separator and a metallic lithium as a counter electrode. Ethylene carbonate/dimethyl carbonate/propylene carbonate comprising 1M LiPF₆ was used as the electrolyte.

### Example 2

A negative active material for a rechargeable lithium battery was prepared by the same procedure as Example 1 except that titanium oxide was used instead of boric acid.

### Example 3

A negative active material for a rechargeable lithium battery was prepared by the same procedure as Example 1 except that nickel oxide was used instead of boric acid.

### Example 4

A negative active material for a rechargeable lithium battery was prepared by the same procedure as Example 1 except that 7 wt % of boric acid and 7 wt % of titanium oxide were used instead of boric acid.

### Example 5

A negative active material for a rechargeable lithium battery was prepared by the same procedure as Example 1 except that 7 wt % of boric acid and 7 wt % of nickel oxide were used instead of boric acid.

### Example 6

A negative active material for a rechargeable lithium battery was prepared by the same procedure as Example 1 except that 7 wt % of boric acid and 7 wt % of manganese oxide were used instead of boric acid.

### Example 7

A negative active material for a rechargeable lithium battery was prepared by the same procedure as Example 1 except that 7 wt % of boric acid and 7 wt % of vanadium oxide were used instead of boric acid.

### Example 8

A negative active material for a rechargeable lithium battery was prepared by the same procedure as Example 1 except that 7 wt % of boric acid and 7 wt % of aluminum oxide were used instead of boric acid.

### Comparative Example 1

Coal tar pitch was subjected to heat-treatment at 300° C. for 3 hours while stirring in the reactor under nitrogen atmosphere to remove volatile components and generating gas such as CO₂, and then subject to heat-treatment at 600° C. to prepare cokes.

After carbonizing the prepared cokes at 1000° C. for 2 hours, the obtained carbide was graphitized at 2800° C. under inactive atmosphere to prepare a negative active material for a rechargeable lithium battery.

A 2016 type rechargeable lithium battery was prepared using the negative active material prepared as above by the same procedure in Example 1.

### Comparative Example 2

A 2016 type rechargeable lithium battery was prepared using mesophase carbon microbead powder by the same procedure in Example 1.

Table 1 below shows the result of measuring discharge capacity, charge-discharge efficiency and I(110)/I(002) of the rechargeable lithium battery prepared by the procedure in Examples 1 to 8 and Comparative Examples 1 and 2.

TABLE 1

| | Discharge capacity | Charge and discharge | |
|---|---|---|---|
| | [mAh/g] | efficiency [%] | I(110)/I(002) |
| Example 1 | 342 | 91.2 | 0.014 |
| Example 2 | 320 | 93.6 | 0.032 |
| Example 3 | 321 | 90.2 | 0.025 |
| Example 4 | 342 | 93.1 | 0.015 |
| Example 5 | 340 | 92.3 | 0.018 |
| Example 6 | 345 | 92.5 | 0.011 |
| Example 7 | 340 | 93.0 | 0.016 |
| Example 8 | 350 | 92.7 | 0.009 |
| Comparative | 302 | 91.5 | 0.043 |
| Example 1 | | | |
| Comparative | 305 | 93 | 0.041 |
| Example 2 | | | |

As can be seen from Table 1, the efficiencies of the batteries of Examples 1 to 8 are similar to those of the batteries of Comparative Examples 1 and 2, however, discharge capacity is superior to those of Comparative Examples 1 and 2. It is believed that I(110)/I(002) of the negative active material according to Examples 1 to 8 is less than or equal to 0.04, which is similar to that of natural graphite with high capacity.

Therefore, the method of preparing the negative active material according to the present invention can improve the graphitization degree by using a graphitization catalyst, which increases the amount of intercalation/deintercalation of lithium ions so that the active material with high discharge capacity can be prepared. In addition, the method of the present invention can provide for active material with excellent initial charge-discharge efficiency because of the low reactivity with an electrolyte.

The present invention has been described in detail herein above. It should be understood that many variations and/or modifications of the basic inventive concepts taught herein which may appear to those skilled in the present art will still fall within the spirit and scope of the present invention, as defined in the appended claims.

1. A negative active material for a rechargeable lithium battery comprising crystalline carbon having a dispersed element serving as graphitization catalyst therein.

2. The negative active material of claim 1, wherein said element serving as graphitization catalyst is at least one material selected from the group consisting of transition metals, alkaline metals, alkaline earth metals, semi-metals of Group 3A, Group 3B, Group 4A and Group 4B of the Periodic Table, elements of Group 5A, and elements of Group 5B.

3. The negative active material of claim 2, wherein said transition metal is at least one selected from the group consisting of Mn, Ni, Fe, Cr, Co, Cu, Mo and W; said alkali metal is at least one selected from the group consisting of Na and K; said alkali earth metal is at least one selected from the group consisting of Ca and Mg; said semi-metal is at least one selected from the group consisting of the semi-metal of Group 3A selected from the group consisting of Sc, Y, lanthanoids and actinoids, the semi-metal of Group 3B selected from the group consisting of B, Al and Ga, the semi-metal of Group 4A selected from the group consisting of Ti and Zr, and the semi-metal of Group 4B selected from the group consisting of Si, Ge and Sn; said elements of Group 5A is at least one selected from the group consisting of V, Nb and Ta; and said elements of Group 5B is at least one selected from the group consisting of P, Sb, and Bi.

4. The negative active material of claim 1, wherein said element serving as graphitization catalyst is present in an amount of 0.01 to 22 wt % on the basis of the negative active material.

5. The negative active material of claim 1, wherein said negative active material comprises 0.01 to 12 wt % of B and 0.01 to 10 wt % of one or more elements selected from the group consisting of transition metals, alkali metals, alkali earth metals, semi-metals of Group 3A, semi-metals of Group 3B, semi-metals of Group 4A, semi-metals of Group 4B, elements of Group 5A, and elements of Group 5B, said transition metals being selected from the group consisting of Mn, Ni, Fe, Cr, Co, Cu, Mo and W; said alkali metals being selected from the group consisting of Na and K; said alkali earth metal being selected from the group consisting of Ca and Mg; said semi-metal of Group 3A being selected from the group consisting of Sc, Y, lanthanoids and actinoids; said semi-metal of Group 3B being selected from the group consisting of Al and Ga, said semi-metal of Group 4A being selected from the group consisting of Ti and Zr; said semi-metal of Group 4B being selected from the group consisting of Si, Ge and Sn; said element of Group 5A being selected from the group consisting of V, Nb and Ta; and said element of Group 5B being selected from the group consisting of P, Sb and Bi.

6. The negative active material of claim 1, wherein an intensity ratio I(110)/I(002) of said negative active material is less than or equal to 0.04, said intensity ratio I(110)/I(002) being defined as an X-ray diffraction peak intensity I(110) at a (110) plane to an X-ray diffraction peak intensity I(002) at a (002) plane.

7. A method of preparing a negative active material for a rechargeable lithium battery comprising:
mixing an element serving as graphitization catalyst with a carbon precursor;
coking the mixture by heat-treating at 300 to 600° C. to form cokes;
carbonizing the cokes to form a carbide; and
graphitizing the carbide at 2800 to 3000° ° C.

8. The method of claim 7, wherein said element serving as graphitization catalyst is at least one material selected from the group consisting of transition metals, alkaline metals, alkaline earth metals, semi-metals of Group 3A, Group 3B, Group 4A and Group 4B of the Periodic Table, elements of Group 5A, and elements of Group 5B.

9. The method of claim 8, wherein said transition metal is at least one selected from the group consisting of Mn, Ni, Fe, Cr, Co, Cu, Mo and W; said alkali metal is at least one selected from the group consisting of Na and K; said alkali earth metal is at least one selected from the group consisting of Ca and Mg; said semi-metal is at least one selected from the group consisting of the semi-metal of Group 3A selected from the group consisting of Sc, Y, lanthanoids and actinoids, the semi-metal of Group 3B selected from the group consisting of B, Al and Ga, the semi-metal of Group 4A selected from the group consisting of Ti and Zr, and the semi-metal of Group 4B selected from the group consisting of Si, Ge and Sn; said elements of Group 5A is at least one selected from the group consisting of V, Nb and Ta; and said elements of Group 5B is at least one selected from the group consisting of P, Sb, and Bi.

10. The method of claim 9, wherein said element serving as graphitization catalyst comprises B and at least one element selected from the group consisting of transition metals, alkali metals, alkali earth metals, semi-metals of Group 3A, semi-metals of Group 3B, semi-metals of Group 4A, semi-metals of Group 4B, elements of Group 5A, and elements of Group 5B, said transition metals being selected from the group consisting of Mn, Ni, Fe, Cr, Co, Cu, Mo and W; said alkali metals being selected from the group consisting of Na and K; said alkali earth metals being selected from the group consisting of Ca and Mg; said semi-metal of Group 3A being selected from the group consisting of Sc, Y, lanthanoids and actinoids; said semi-metal of Group 3B being selected from the group consisting of Al and Ga, said semi-metal of Group 4A being selected from the group consisting of Ti and Zr; said semi-metal of Group 4B being selected from the group consisting of Si, Ge and Sn; said element of Group 5A being selected from the group consisting of V, Nb and Ta; and said element of Group SB being selected from the group consisting of P, Sb, and Bi.

11. The method of claim 7, wherein said element serving as graphitization catalyst is added in an amount of 0.01 to 22 wt % on the basis of carbon precursor.
